(19) United States
(12) Patent Application Publication
(10) Pub. No.: US 2009/0323326 A1
(43) Pub. Date: Dec. 31, 2009

(54) LIGHT DIFFUSION PLATE AND BACKLIGHT MODULE USING THE SAME

(75) Inventor: SHAO-HAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/205,933

(22) Filed: Sep. 8, 2008

(30) Foreign Application Priority Data
Jun. 30, 2008 (CN) 200810302454.9

(51) Int. Cl. G02B 5/02; F21V 11/00

(52) U.S. Cl. 362/235; 359/599

(57) ABSTRACT

An exemplary light diffusion plate includes a main body, and a plurality of diffusion particles dispersed in the main body. The main body includes a first surface and a second surface. The first surface and the second surface are on opposite sides of the main body. The first surface is a flat surface. The second surface defines a plurality of rectangular structures. Each rectangular structure defines four adjacent triangular pyramid depressions. A backlight module using the light diffusion plate is also provided.

### BACKGROUND OF THE DISCLOSURE

1. Field of the Invention

The present disclosure relates to an optical plate, and particularly to a light diffusion plate employed in a direct type backlight module.

2. Description of the Related Art

Referring to FIG. 6, one such direct type backlight module 100 includes a frame 11, a plurality of point light sources 12, a light diffusion plate 13, and a prism sheet 10. The point light sources 12 are regularly arranged on a base of the frame 11. The light diffusion plate 13 and the prism sheet 10 are disposed on the point light sources 12 above a top of the frame 11 in that order. The light diffusion plate 13 includes a plurality of diffusion particles (not shown) configured for diffusing light. The prism sheet 10 includes a transparent substrate 101 and a prism layer 103 formed on a surface of the transparent substrate 101. The prism layer 103 forms a plurality of elongated V-shaped ridges 105.

In use, light from the point light sources 12 enters the diffusion plate 13 and becomes scattered. The scattered light leaves the diffusion plate 13 to the prism sheet 10. The scattered light then travels through the prism sheet 10 and is refracted out at the elongated V-shaped ridges 105 of the prism sheet 10. The refracted light leaving the prism sheet 10 is concentrated at the prism layer 103 and increases the brightness (illumination) of the prism sheet 10. The refracted light then propagates into a liquid crystal display panel (not shown) disposed above the prism sheet 10.

However, although light from point the light sources 12 enters the diffusion plate 13 and becomes scattered, after the light leaves the prism sheet 10, strong light spots of the point light sources 12 often occurs.

In order to reduce or eliminate the strong light spots of the point light sources 12, the backlight module 100 should further include an upper light diffusion film 14 disposed on the prism sheet 10. However, although the upper light diffusion film 14 and the prism sheet 10 are in contact with each other, a plurality of air pockets may still exist around the boundaries of the light diffusion film 14, the prism sheet 10, and the light diffusion plate 13. When the backlight module 100 is in use, light passes through the air pockets, and some of the light undergoes total reflection by the air pockets along one or another of the corresponding boundaries. In addition, the upper light diffusion film 14 may absorb a certain amount of the light from the prism sheet 10. As a result, a brightness of light illumination of the backlight module 100 is reduced.

Additionally, the direct type backlight module 100 is often manufactured in various sections and thus, have to be integrated together. The integration of the various sections of the direct type backlight module 100 often reduces the rigidity and mechanical strength of the direct type backlight module 100. The reduced rigidity and mechanical strength may result in reduced reliability of the direct type backlight module 100.

Therefore, a new light diffusion plate is desired in order to overcome the above-described shortcomings.

### SUMMARY

A light diffusion plate includes a main body, and a plurality of diffusion particles dispersed in the main body. The main body includes a first surface and a second surface. The second surface is opposite to the first surface of the main body. The first surface has a flat surface. The second surface defines a plurality of rectangular structures. Each rectangular structure defines four adjacent triangular pyramid depressions.

A backlight module includes a frame, a plurality of point light sources, and a light diffusion plate. The point light sources are regularly arranged on a base of the frame. The light diffusion plate is disposed on the point light sources above a top of the frame. The light diffusion plate is the same plate described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present light diffusion plate. Moreover, in the drawings, like reference numerals designate corresponding parts throughout several views, and all the views are schematic.

FIG. 1 is an isometric view of a light diffusion plate in accordance with a first embodiment of the present disclosure.

FIG. 2 is a side cross-sectional view taken along the line II-II of FIG. 1.

FIG. 3 is a top plan view of a light diffusion plate in accordance with a second embodiment of the present disclosure.

FIG. 4 is a side cross-sectional view of a light diffusion plate in accordance with a third embodiment of the present disclosure.

FIG. 5 is a side cross-sectional view of a backlight module in accordance with a fourth embodiment of the present disclosure.

FIG. 6 is a side cross-sectional view of a backlight module.

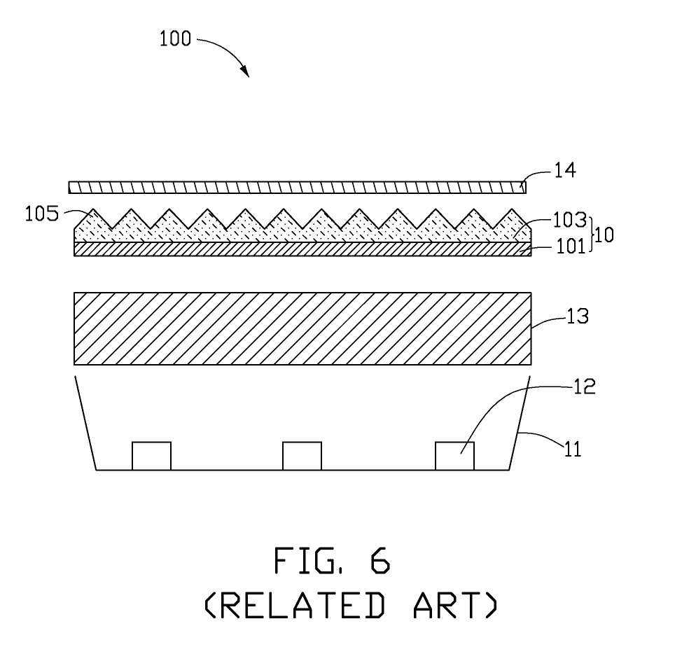

### DETAILED DESCRIPTION

Reference will now be made to the drawings to describe various inventive embodiments of the present light diffusion plate in detail.

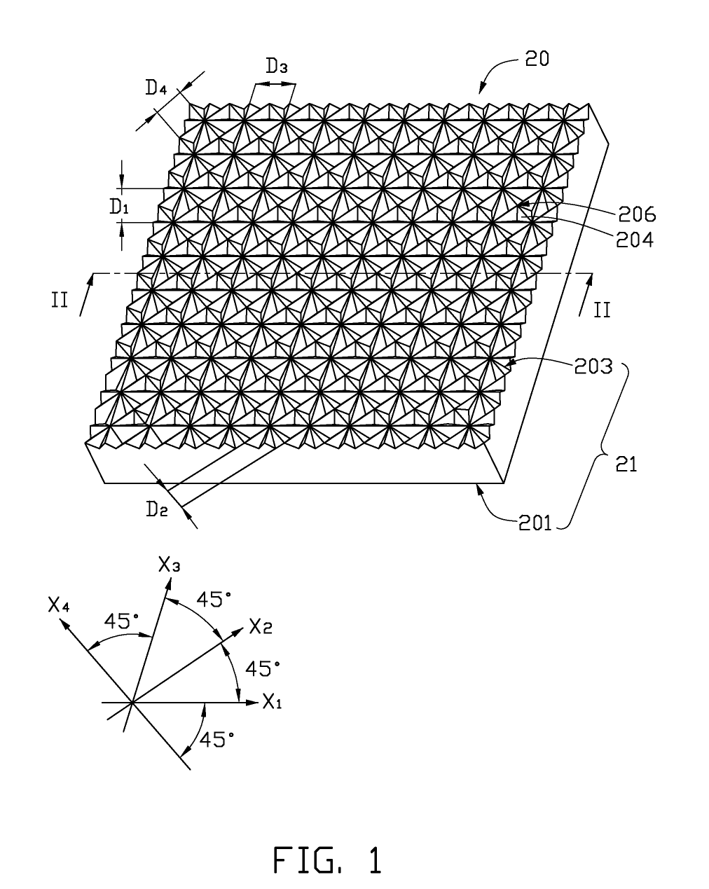

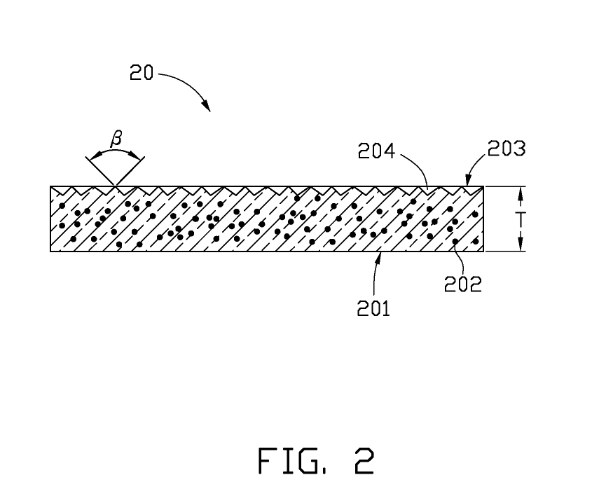

Referring to FIGS. 1 and 2, a light diffusion plate 20, of a first embodiment of the present disclosure, includes a main body 21. The main body 21 includes a first surface 201 and a second surface 203. The first surface 201 and the second surface 203 are on opposite sides of the main body 21. The first surface 201 is a flat surface. The second surface 203 defines a plurality of rectangular structures 206 and each rectangular structure 206 defines four adjacent triangular pyramid depressions 204. Each side of the rectangular structure 206 is bordered with a side of another adjacent rectangular structure 206.

The triangular pyramid depressions 204 are closely connected. In each rectangular structure 206, the four triangular pyramid depressions 204 together with the sidewalls thereof cooperatively form a four-pointed star. The four-pointed stars are distributed in a matrix manner in the second surface 203.

In the illustrated embodiment, corresponding sidewalls on each side of adjacent pyramid depressions 204 sharing a same edge collectively form V-shaped ridges, namely, a plurality of first V-shaped ridges, a plurality of second V-shaped ridge, a plurality of third V-shaped ridges, and a plurality of fourth V-shaped ridges. The first V-shaped ridges extend along a first direction X₁. The second V-shaped ridges extend along a second direction X₂. The third V-shaped ridges extend along a third direction X₃. The fourth V-shaped ridges extend along a fourth direction X₄.

The first, second, third, and fourth V-shaped ridges intersect with one another and cooperatively define the triangular pyramid depressions 204. In addition, the first V-shaped ridges and the third V-shaped ridges intersect with each other and form a plurality of intersections. Each of the plurality of intersections also intersects the second V-shaped ridges and the fourth V-shaped ridges correspondingly.

The first direction X₁ and the second direction X₂ cooperatively define an angle θ₁, the second direction X₂ and the third direction X₃ cooperatively define an angle θ₂, the third direction X₃ and the fourth direction X₄ cooperatively define an angle θ₃, and the first direction X₁ and the fourth direction X₄ cooperatively define an angle θ₄. The angles θ₁, θ₂, θ₃, θ₄, are all about 45 degrees.

A vertex angle β of the V-shaped ridge is in the range from about 80 degrees to about 100 degrees. A pitch of the adjacent first V-shaped ridges is in the range from about 0.025 millimeters to about 1 millimeter. In the illustrated embodiment, the relations of the first, the second, the third, and the fourth V-shaped ridges are determined by the formula: D₁=D₃=\sqrt{2} D₂=\sqrt{2} D₄, wherein D₁ represents a pitch between the adjacent first V-shaped ridges, D₂ represents a pitch between the adjacent second V-shaped ridges, D₃ represents a pitch between the third adjacent V-shaped ridges, and D₄ represents a pitch between the adjacent fourth V-shaped ridges.

Referring to FIG. 2 again, a thickness T of the light diffusion plate 20 is in the range from about 0.4 millimeters to about 4 millimeters. The light diffusion plate 20 includes a matrix resin (not labeled) and a plurality of diffusion particles 202 dispersed in the matrix resin. The matrix resin is selected from the group consisting of polycarbonate, polymethyl methacrylate, polystyrene, copolymer of methyl methacrylate and styrene, and any suitable combination of those. The diffusion particles 202 are selected from the group consisting of silicon dioxide particles, titanium dioxide particles, acrylate copolymer particles and any combination of those. The light diffusion plate 20 preferably has a light transmission ratio in the range from larger than 80% to less than 100%. A mold used to manufacture the light diffusion plate 20 includes a plurality of triangular pyramid protrusions formed on a second side surface. The triangular pyramid protrusions are configured to form the triangular pyramid depressions 204 on the second surface 203 of the light diffusion plate 20, such that the light diffusion plate 20 can be produced at a same time per injection molding.

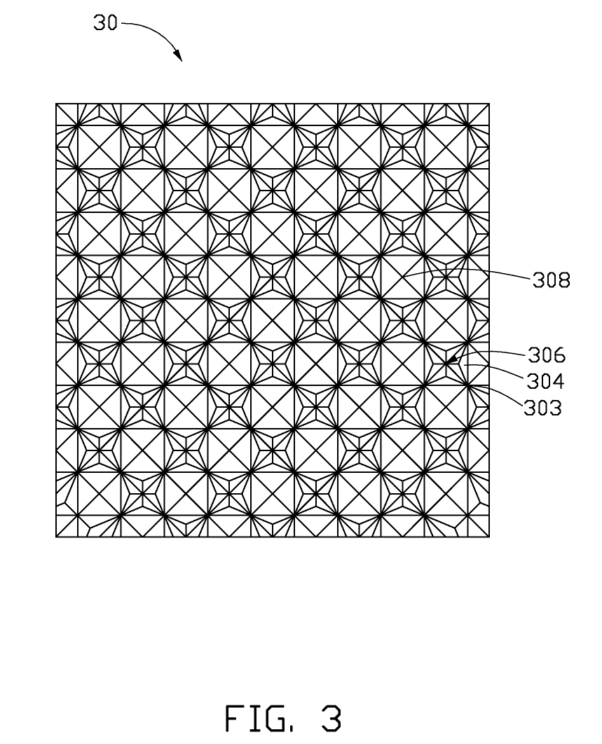

Referring to FIG. 3, a light diffusion plate 30 in accordance with a second embodiment of the present disclosure is shown. The light diffusion plate 30 is similar in principle to the light diffusion plate 20 of the first embodiment of the present disclosure, but the second surface 303 defines a plurality of rectangular structures 306 and a plurality of quadrilateral pyramid depressions 308. Each rectangular structure 306 defines four adjacent triangular pyramid depressions 304. Each side of the rectangular structures 306 borders one side of one quadrilateral pyramid depression 308.

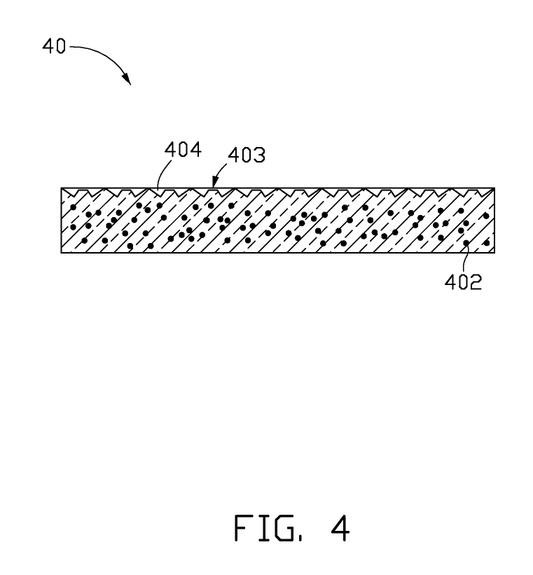

Referring to FIG. 4, a light diffusion plate 40 in accordance with a third embodiment of the present disclosure is shown. The light diffusion plate 40 is similar in principle to the light diffusion plate 20 of the first embodiment, but has a plurality of the triangular pyramid depressions 404 that are defined in the second surface 403. However, a top end of the V-shaped ridges is flat. Because the top end of the V-shaped ridges is flat, mechanical strength of the V-shaped ridges is enhanced. As a result, the light diffusion plate 40 has a higher reliability than a light diffusion plate with the V-shaped ridges having a top that becomes easily damaged when used.

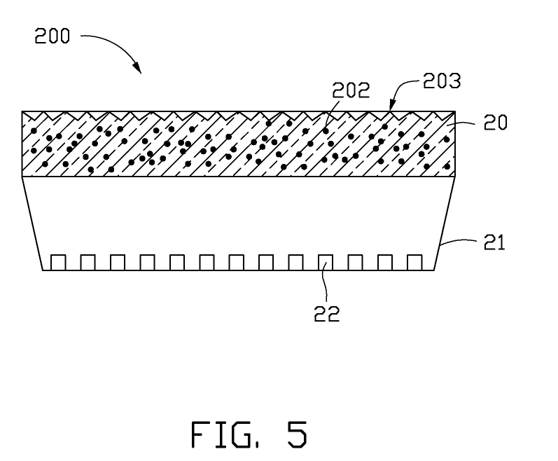

Referring to FIG. 5, a backlight module 200 in accordance with a fourth embodiment of the present disclosure is shown. The backlight module 200 includes a frame 21, a plurality of point light sources 22, and a light diffusion plate 20. The point light sources 22 are regularly arranged on a base of the frame 21. The light diffusion plate 20 is disposed on the point light sources 22 above a top of the frame 21. The light diffusion plate 20 is described above. The first surface 201 of the light diffusion plate 20 is facing the point light sources 22 and the second surface 203 of the light diffusion plate 20 is farther away from the point light sources 22. Light enters the light diffusion plate 20 via the first surface 201.

In the illustrated embodiment of FIG. 3, light emitted from the light diffusion plate 20 of the backlight module 200 forms a plurality of smaller light spots according to each of the point light sources 22. Thus, a relatively uniform surface light source is achieved. Therefore, when the light diffusion plate 20 is employed in a backlight module, strong light spots of the light sources seldom occurs, more uniform light is achieved, and there is no need to add an upper light diffusion film between the light diffusion plate 20 and the liquid crystal display panel. Thus, the efficiency of light utilization is enhanced.

In addition, because the triangular pyramid depressions 204 form the first, the second, the third, and the fourth V-shaped ridges, light emitted from the second surface 203 concentrates in planes perpendicular to the first direction X₁, the second direction X₂, the third direction X₃, and the fourth direction X₄ respectively, thereby increasing the brightness (illumination) of the light diffusion plate 20 along a direction perpendicular to the second surface 203. Thus, there is no need to add a prism sheet between the light diffusion plate 20 and the liquid crystal display panel.

Furthermore, the light diffusion plate 20 is integrally formed by injection molding technology. The injection molding process causes the light diffusion plate 20 to have a stronger rigidity and mechanical strength because the light diffusion plate is formed as a whole unit integrally. Thus the light diffusion plate 20 has a relatively high reliability.

Finally, while various inventive embodiments has been described and illustrated, the present disclosure is not to be construed as being limited thereto. Various modifications can be made to the embodiments by those of ordinary skill in the art without departing from the true spirit and scope of the disclosure as defined by the appended claims.

What is claimed is:

1. A light diffusion plate comprising:
a main body, and a plurality of diffusion particles dispersed in the main body, the main body comprising:
a first surface, the first surface having a flat surface; and
a second surface opposite to the first surface of the main body, the second surface defining a plurality of rectangular structures, each rectangular structure defining four adjacent triangular pyramid depressions.

2. The light diffusion plate as claimed in claim 1, wherein each of the plurality of the rectangular structures borders with four other of the plurality of the rectangular structures, and wherein sidewalls on each side of adjacent depressions sharing a same edge collectively form a plurality of first V-shaped ridges extending along a first direction, a plurality of second V-shaped ridge extending along a second direction, a plurality of third V-shaped ridges extending along a third direction, and a plurality of fourth V-shaped ridge extending along a fourth direction, the first V-shaped ridges and the third V-shaped ridges intersecting with each other and form a plurality of intersections, each of the plurality of intersections also intersecting the second V-shaped ridges and the fourth V-shaped ridges correspondingly.

3. The light diffusion plate as claimed in claim 2, wherein an angle defined by the first direction and the second direction, an angle defined by the second direction and the third direction, an angle defined by the third direction and the fourth direction, and an angle defined by the fourth direction and the first direction are about 45 degrees.

4. The light diffusion plate as claimed in claim 2, wherein a vertex angle of each of the V-shaped ridges is in the range from about 80 degrees to about 100 degrees.

5. The light diffusion plate as claimed in claim 2, wherein at least one portion of the top end of the V-shaped ridge is flat.

6. The light diffusion plate as claimed in claim 1, wherein the thickness of the light diffusion plate is in the range from about 0.4 millimeters to about 4 millimeters.

7. The light diffusion plate as claimed in claim 1, wherein the main body is made of a matrix resin selected from the group consisting of polycarbonate, polymethyl methacrylate, polystyrene, and copolymer of methyl methacrylate and styrene.

8. The light diffusion plate as claimed in claim 1, wherein the diffusion particles are selected from the group consisting of silicon dioxide particles, titanium dioxide particles, and acrylate copolymer particles.

9. The light diffusion plate as claimed in claim 1, wherein the second surface further defines a plurality of quadrilateral pyramid depressions, and each side of each of the plurality of rectangular structures borders with one side of one of the quadrilateral pyramid depressions.

10. A backlight module comprising:
a frame,
a plurality of point light sources arranged on a base of the frame, and
a light diffusion plate disposed on the point light source at a top of the frame,
wherein the light diffusion plate comprises a main body, and a plurality of diffusion particles dispersed in the main body, the main body comprising: a first surface, the first surface having a flat surface; and a second surface opposite to the first surface of the main body, the second surface defining a plurality of rectangular structures, each rectangular structure defining four adjacent triangular pyramid depressions.

11. The backlight module as claimed in claim 10, wherein each of the plurality of the rectangular structures borders with four other of the plurality of the rectangular structures, and wherein sidewalls on each side of adjacent depressions sharing a same edge collectively form a plurality of first V-shaped ridges extending along a first direction, a plurality of second V-shaped ridge extending along a second direction, a plurality of third V-shaped ridges extending along a third direction, and a plurality of fourth V-shaped ridge extending along a fourth direction, the first V-shaped ridges and the third V-shaped ridges intersecting with each other and form a plurality of intersections, each of the plurality of intersections also intersect the second V-shaped ridges and the fourth V-shaped ridges correspondingly.

12. The backlight module as claimed in claim 1, wherein an angle defined by the first direction and the second direction, an angle defined by the second direction and the third direction, an angle defined by the third direction and the fourth direction, and an angle defined by the fourth direction and the first direction are about 45 degrees.

13. The backlight module as claimed in claim 1, wherein a vertex angle of each of the V-shaped ridges is in the range from about 80 degrees to about 100 degrees.

14. The backlight module as claimed in claim 11, wherein at least one portion of the top end of the V-shaped ridge is flat.

15. The backlight module as claimed in claim 10, wherein the thickness of the light diffusion plate is in the range from about 0.4 millimeters to about 4 millimeters.

16. The backlight module as claimed in claim 10, wherein the main body is made of a matrix resin selected from the group consisting of polycarbonate, polymethyl methacrylate, polystyrene, and copolymer of methyl methacrylate and styrene.

17. The backlight module as claimed in claim 10, wherein the diffusion particles are selected from the group consisting of silicon dioxide particles, titanium dioxide particles, and acrylate copolymer particles.

18. The backlight module as claimed in claim 10, wherein the second surface further defines a plurality of quadrilateral pyramid depressions, and each side of each of the plurality of rectangular structures borders with one side of one of the quadrilateral pyramid depressions.
